(19) United States
(12) Patent Application Publication
(10) Pub. No.: US 2010/0183809 A1
(43) Pub. Date: Jul. 22, 2010

(54) SURFACE-TREATED PIGMENT, INK COMPOSITION, AND INK JET RECORDING METHOD

(75) Inventors: Takashi OYANAGI, Matsumoto-shi (JP); Tsuyoshi Sano, Shiojiri-shi (JP); Takayoshi Kagata, Shiojiri-shi (JP); Hiroki Nakane, Matsumoto-shi (JP); Fukui Toshimi, Otsu City (JP); Kawasaki Hideki, Ritto City (JP); Nakamoto Junko, Osaka-shi (JP); Yamaki Saori, Kawasaki-shi (JP)

Correspondence Address: LADAS & PARRY, 26 West 61st Street, New York, NY, 10023, US

(73) Assignee: SEIKO EPSON CORPORATION

(21) Appl. No.: 12/690,293

(22) Filed: Jan. 20, 2010

(30) Foreign Application Priority Data
Jan. 20, 2009 (JP) 2009-009628

(51) Int. Cl. B05D 5/00; C09C 1/62; C09C 1/64; C08K 5/541

(52) U.S. Cl. 427/256; 106/403; 106/404; 524/265

(57) ABSTRACT

Provided is a surface-treated pigment that is a metallic pigment composed of plate-like particles of which surfaces are treated with an alkoxysilane compound having at least one long-chain alkyl group.

### BACKGROUND

1. Technical Field

The present invention relates to a surface-treated pigment, an ink composition, and an ink jet recording method, and, in particular, relates to a surface-treated pigment, an ink composition, and an ink jet recording method that enable forming an image improved in metallic gloss.

2. Related Art

In order to form a coating having a metallic gloss on a printed matter, it has been employed a thermal transfer system in which metallic foil is used or foil stamping printing in which a printing ink including a gold or silver powder made from brass or aluminum fine particles or metallic foil is used. These methods have limitation that the recording medium is limited to, for example, a medium having high resistance to heat and deformation.

Recently, a technology for enhancing the gloss by treating the surface of a metallic pigment has been developed as an application to printing.

For example, JP-A-8-283604 discloses a surface-treating agent for flake pigment composed of a polyglycidyl ether compound, a polyglycidyl ester compound, and/or a diglycidyl polysiloxane compound, a flake pigment having a surface composed of a metal oxide and/or hydrated metal oxide layer treated with the surface-treating agent, and a method for producing the flake pigment, in order to provide a novel surface-treating agent and a surface-treated flake pigment treated with the surface-treating agent that is useful for paint, ink, or the like.

Furthermore, JP-T-2005-501955 discloses an ink composition including a) a binder system, b) water, and c) a pigment selected from the group consisting of interference pigments containing a stack of layers made of different materials. At least one of the layers is a reflective layer having at least one chemically exposed surface, and at least one of the layers is a dielectric layer having at least one chemically exposed surface. The materials include one or more metals and/or an inorganic metal compound that are sensitive to corrosion. The at least chemically exposed surfaces of the reflective layer and the dielectric layer are substantially covered with a passivating agent at the ends of the stack of layers. The passivating agent is selected from the group consisting of anion surfactants, preferably the group consisting of organic esters and fluorinated organic esters of phosphoric acid. In the ink composition, the reflective layer of an optically variable pigment is selected from the group of metals such as aluminum.

However, it is the current status that the effect of metallic printing using the metallic pigment applied with the above-described treatment is still unsatisfactory in the metallic specular gloss.

### SUMMARY

An advantage of some aspects of the invention is to provide a pigment, an ink composition, and an ink jet recording method using the ink composition that can exhibit a higher metallic specular gloss, focusing on the technology for treating metallic pigment surfaces.

In order to solve the above-mentioned problems, the present inventors have conducted intensive studies and have obtained the finding that the above-mentioned object can be achieved by a pigment dispersion containing a surface-treated metallic pigment composed of plate-like particles of which surfaces are treated with a specific compound, an ink composition, an ink jet recording method, and a recorded matter. The invention has been made based on such finding, and the followings are provided:

1. A surface-treated pigment, the pigment being a metallic pigment composed of plate-like particles of which surfaces are treated with an alkoxysilane compound having at least one long-chain alkyl group;
2. The surface-treated pigment according to the above 1, wherein the long-chain alkyl group in the alkoxysilane compound has 4 to 12 carbon atoms;
3. The surface-treated pigment according to the above 1, wherein the metallic pigment composed of the plate-like particles has flat surfaces with a major axis X, a minor axis Y, and a thickness Z that satisfy the requirements that the 50% average particle size R50 based on circle-equivalent diameters determined from the X-Y plane areas of the plate-like particles is from 0.5 to 3 μm and the value of R50/Z is larger than 5;
4. The surface-treated pigment according to any one of the above 1 to 3, wherein the maximum particle size Rmax based on circle-equivalent diameters determined from the X-Y plane areas of the plate-like particles is 10 μm or less;
5. The surface-treated pigment according to any one of the above 1 to 4, wherein the metallic pigment is aluminum or an aluminum alloy;
6. The surface-treated pigment according to any one of the above 1 to 5, wherein the metallic pigment is produced by pulverizing a deposited metal film;
7. An ink composition including the surface-treated pigment according to any one of the above 1 to 6, an organic solvent, and a resin;
8. The ink composition according to the above 7, wherein the ink composition contains the surface-treated metallic pigment in a concentration of 0.1 to 3.0% by weight;
9. The ink composition according to the above 7 or 8, wherein the organic solvent contains at least one alkylene glycol ether that is a liquid at ordinary temperature and ordinary pressure;
10. The ink composition according to the above 7 or 8, wherein the organic solvent is a mixture of an alkylene glycol diether, an alkylene glycol monoether, and a lactone;
11. The ink composition according to any one of the above 7 to 10, wherein the resin is at least one selected from the group consisting of polyvinyl butyral, cellulose acetate butyrate, and polyacrylic polyol resins;
12. An ink jet recording method for recording by discharging droplets of the ink composition according to any one of the above 7 to 11 and attaching the droplets onto a recording medium, wherein the amount of the ink composition discharged on the recording medium is 0.1 to 100 mg/cm²;
13. The ink jet recording method according to the above 12, wherein the ink composition is discharged by a non-heating system;
14. The ink jet recording method according to the above 12 or 13, wherein printing is conducted with heating the recording medium;
15. The ink jet recording method according to the above 14, wherein the heating temperature is 30 to 80° C.; and
16. The ink jet recording method according to the above 15, wherein the heating is conducted before the printing and/or during the printing and/or after the printing.

According to the invention, an image having a higher metallic gloss can be formed on a recording medium by using a metallic pigment that is a pigment composed of plate-like particles of which surfaces are treated with a specific compound.

### DESCRIPTION OF EXEMPLARY EMBODIMENTS

### Surface-Treated Pigment

A surface-treated pigment of an embodiment is that in which the surface of a metallic pigment composed of plate-like particles (hereinafter, also referred to as “metallic pigment”) is treated with an alkoxysilane compound having at least one long-chain alkyl group.

The surface-treated pigment of the embodiment has the above-mentioned constitution and thereby can form an image having a higher metallic gloss on a recording medium. That is, a printed surface having a higher metallic gloss can be obtained by controlling the affinity of a specific metallic pigment to an organic solvent constituting a main component of an ink composition and controlling the orientation conditions of the plate-like particles on a printing surface by treating the surface of the pigment as described above.

In the alkoxysilane compound having at least one long-chain alkyl group used in the embodiment, the number of carbon atoms of the long-chain alkyl group is preferably 4 to 12 and particularly preferably 6 to 10, because they can further control the orientation conditions on a printing surface. Examples of such a compound include hexyltrimethoxysilane, hexyltriethoxysilane, decyltrimethoxysilane, n-octyltriethoxysilane, and n-dodecyltriethoxysilane.

In the embodiment, the surface-treated pigment can be prepared by, for example, adding an alkoxysilane compound having at least one long-chain alkyl group to a pigment dispersion containing a metallic pigment so that the concentration of the compound is 0.01 to 0.05 mol/L and performing a reaction at 10 to 70° C. for 4 to 48 hours.

The metallic pigment used in the embodiment is plate-like particles produced by, for example, pulverizing a deposited metallic film, and the plate-like particles have flat surfaces with a major axis X, a minor axis Y, and a thickness Z that satisfy the requirements that the 50% average particle size R50 based on circle-equivalent diameters determined from the X-Y plane areas of the plate-like particles is from 0.5 to 3 μm and R50/Z>5.

The term “plate-like particle” refers to a particle having an approximately flat surface (X-Y plane) and an approximately uniform thickness (Z). Since the plate-like particles are produced by pulverizing a deposited metal film, the metallic particles can have approximately flat surfaces and approximately uniform thicknesses. Accordingly, the major axis and the minor axis of the flat surface of the plate-like particle can be defined as X and Y, respectively, and the thickness can be defined as Z.

The term “circle-equivalent diameter” refers to the diameter of a circle that has the same projected area as that of the approximately flat surface (X-Y plane) of the plate-like particle of a metallic pigment. For example, if the approximately flat surface (X-Y plane) of the plate-like particle of the metallic pigment is a polygon, the diameter of a circle obtained by converting the projected image of the polygon so that the circle has the same area as that of the polygon is the circle-equivalent diameter of the plate-like particle of the metallic pigment.

The 50% average particle size R50 based on circle-equivalent diameters determined from the X-Y plane areas of the plate-like particles is preferably 0.5 to 3 μm and more preferably 0.75 to 2 μm, from the viewpoints of metallic gloss and printing stability. A 50% average particle size R50 of smaller than 0.5 μm causes lack of gloss. On the other hand, a 50% average particle size R50 of larger than 3 μm causes a decrease in printing stability.

Regarding the relationship between the thickness Z and the 50% average particle size R50 based on circle-equivalent diameters, the value of R50/Z is larger than 5 (R50/Z>5) from the viewpoint of ensuring a high metallic gloss. If the value of R50/Z is not higher than 5, a problem of lack of a metallic gloss occurs.

The maximum particle diameter Rmax based on circle-equivalent diameters determined from the X-Y plane areas of the plate-like particles is preferably 10 μm or less from the viewpoint of preventing clogging of the ink composition in an ink jet recording apparatus. By regulating the Rmax to 10 μm or less, clogging of, for example, the nozzle of an ink jet recording apparatus and the mesh filter disposed in an ink channel can be prevented.

The metallic pigment is preferably aluminum or an aluminum alloy from the viewpoints of cost performance and ensuring a metallic gloss. In the case of using an aluminum alloy, the metallic or nonmetallic element added to aluminum is not particularly limited as long as the element has functions such as having a metallic gloss. Examples of the element include silver, gold, platinum, nickel, chromium, tin, zinc, indium, titanium, and copper, and at least one of these simple elements, their alloys, and mixtures thereof can be preferably used.

In a method of producing the metallic pigment, the plate-like particles are produced, for example, from a composite pigment base substrate having a structure in which a peeling resin layer and a metal or alloy layer are sequentially laminated on a sheet-like base material, by peeling the metal or alloy layer from the sheet-like base material at the interface between the metal or alloy layer and the peeling resin layer, and pulverizing the metal or alloy layer into plate-like particles reduced in size. Then, the resulting plate-like particles having flat surfaces with a major axis X, a minor axis Y, and a thickness Z that satisfy the requirements that the 50% average particle size R50 based on circle-equivalent diameters determined from the X-Y plane areas of the plate-like particles is 0.5 to 3 μm and R50/Z>5 are collected.

The major axis X, the minor axis Y, and the circle-equivalent diameter of the flat surface of the metallic pigment (plate-like particle) can be measured with a particle image analyzer. As the particle image analyzer, for example, a flow particle image analyzer, FPIA-2100, FPIA-3000, or FPIA-3000S, manufactured by Sysmex Corp., can be used.

The particle size distribution (CV value) of the metallic pigment (plate-like particles) is determined by the following equation:

CV value=(standard deviation of particle distribution)/(average particle diameter)×100. Equation 1

Here, the resulting CV value is preferably 60 or less, more preferably 50 or less, and most preferably 40 or less. The controlling of the CV value of the metallic pigment to 60 or less gives excellent printing stability.

The metal or alloy layer is preferably formed by vacuum deposition, ion plating, or sputtering.

The metal or alloy layer is formed so as to have a thickness of 20 nm or more and 100 nm or less. By doing so, the pigment can have an average thickness of 20 nm or more and 100 nm or less. By controlling the thickness to 20 nm or more, excellent reflectivity and brilliance are imparted to increase the performance as a metallic pigment, and by controlling the thickness to 100 nm or less, an increase in apparent specific gravity is suppressed to secure the dispersion stability of the metallic pigment.

The peeling resin layer of the composite pigment base substrate is an undercoat layer for the metal or alloy layer and also serves as a peelable layer for improving the peelability from the sheet-like base material. Preferred examples of the resin used for the peeling resin layer include polyvinyl alcohol, polyvinyl butyral, polyethylene glycol, polyacrylic acid, polyacrylamide, cellulose derivatives, acrylic acid polymers, and denatured nylon resins.

The layer is formed by applying a solution of a mixture of one or more of the above-mentioned resins to a base material, followed by drying, for example. The application solution may contain an additive such as a viscosity modifier.

The application of the peeling resin layer is performed by a usual method such as gravure coating, roll coating, blade coating, extrusion coating, dip coating, or spin coating. After the application and drying, if necessary, the surface is smoothed by calender treatment.

The thickness of the peeling resin layer is not particularly limited, but is preferably 0.5 to 50 μm and more preferably 1 to 10 μm. A thickness smaller than 0.5 μm is an insufficient amount as a dispersion resin. A thickness larger than 50 μm causes peeling at the interface with the pigment layer when rolled.

The sheet-like base material is not particularly limited, and examples thereof include polyester films such as polytetrafluoroethylene, polyethylene, polypropylene, and polyethylene terephthalate; polyamide films such as Nylon 66 and Nylon 6; and mold-releasing films such as polycarbonate films, triacetate films, and polyimide films. A Preferred sheet-like base material is polyethylene terephthalate or a copolymer thereof.

The thickness of the sheet-like base material is not particularly limited, but is preferably 10 to 150 μm. A thickness of 10 μm or more does not cause problems in handling during a processing step or the like, and a thickness of 150 μm or less imparts high flexibility and does not cause problems in, for example, rolling and peeling.

The metal or alloy layer may be disposed between protection layers as described in JP-A-2005-68250. Examples of the protection layers include silicon oxide layers and resin protection layers.

The silicon oxide layer is not particularly limited as long as the layer contains silicon oxide, but is preferably formed of an silicon alkoxide such as tetraalkoxysilane or a polymer thereof by a sol-gel method.

A coating film serving as the silicon oxide layer is formed by applying an alcohol solution dissolving the silicon alkoxide or a polymer thereof, followed by heating and baking.

The protection resin layer is made of a resin not being dissolved in a dispersion medium without particular limitation. Examples of the resin include polyvinyl alcohol, polyethylene glycol, polyacrylic acid, polyacrylamide, and cellulose derivatives. The layer is preferably formed of polyvinyl alcohol or a cellulose derivative.

The layer is formed by applying an aqueous solution of a mixture of one or more of the above-mentioned resins, followed by drying, for example. The application solution may contain an additive such as a viscosity modifier.

The application of silicon oxide and a resin can be performed by the same method as in the application of the peeling resin layer.

The thickness of the protection layer is not particularly limited, but is preferably in the range of from 50 to 150 nm. A thickness of smaller than 50 nm causes insufficient mechanical strength. A thickness of larger than 150 nm causes difficulties in pulverization and dispersion due to too high strength and further may cause peeling at the interface with the metal or alloy layer.

Furthermore, a color material layer may be provided between the “protection layer” and the “metal or alloy layer”, as described in JP-A-2005-68251.

The color material layer is provided for obtaining an arbitrary colored composite pigment and is not particularly limited as long as it can contain a color material that can impart arbitrary tone and hue to the metallic pigment used in the invention, in addition to the metallic gloss and brilliance. The color material used in the color material layer may be either a dye or a pigment, and known dyes and pigments can be arbitrarily used.

The “pigment” used in the color material layer in this case refers to those defined in the field of general pigment chemistry, such as natural pigments, synthetic organic pigments, and synthetic inorganic pigments, and is different from those processed in a laminate structure, such as the “composite pigment” in the invention.

The formation method of the color material layer is not particularly limited, but is preferably formed by coating.

When the color material used in the color material layer is a pigment, it is preferable that the layer further contain a color material-dispersing resin. The color material layer containing a color material-dispersing resin is preferably formed as a thin resin film by dispersing or dissolving the pigment, the color material-dispersing resin, and, according to need, other additives in a solvent, forming a uniform liquid film of the resulting solution by spin coating, and drying it.

In addition, in the production of the composite pigment base substrate, it is preferable from the standpoint of work efficiency that both the color material layer and the protection layer be formed by coating.

The composite pigment base substrate may have a layer configuration having a plurality of structures in which the peeling resin layer and the metal or alloy layer are sequentially laminated. In such a case, the total thickness of the laminar structure composed of a plurality of metal or alloy layers, that is, the thickness of (metal or alloy layer/peeling resin layer/metal or alloy layer) or (peeling resin layer/metal or alloy layer), excluding the sheet-like base material and the peeling resin layer directly disposed thereon, is preferably 5000 nm or less. A thickness not larger than 5000 nm hardly causes cracking and peeling in the composite pigment base substrate even when it is rolled and thus provides excellent storage properties. In addition, after being formed into a pigment, excellent brilliance is preferably imparted.

In addition, the resin layer and the metal or alloy layer may be laminated alternately on each of both surfaces of the sheet-like base material, but the configuration is not limited to these structures.

The peeling method from the sheet-like base material is not particularly limited. Preferred is a method in which the composite pigment base substrate is immersed in a liquid for peeling or a method in which the composite pigment base substrate is immersed in a liquid and is simultaneously sonicated for performing peeling and pulverization of the peeled composite pigment at the same time.

In the thus-obtained pigment, the peeling resin layer functions as protective colloid, and thereby a stable dispersion can be obtained by only performing dispersion treatment in a solvent. In an ink composition containing the pigment, the resin derived from the peeling resin layer also can have a function of imparting an adhesive property to the pigment against a recording medium such as paper.

### Ink Composition

The ink composition of the embodiment contains the metallic pigment of which surface is treated with the above-described specific compound, an organic solvent, and a resin.

When an ink set includes only one type of metallic ink composition, the concentration of the metallic pigment in the ink composition is preferably 0.1 to 3.0% by weight, more preferably 0.25 to 2.5% by weight, and most preferably 0.5 to 2.0% by weight.

When an ink set includes a plurality of metallic ink compositions, the concentration of the metallic pigment in at least one of the ink compositions is preferably 0.1% by weight or more and less than 1.5% by weight, and the concentration of the metallic pigment in at least another ink composition is preferably 1.5% by weight or more and 3.0% by weight or less.

When the concentration of the metallic pigment in the ink composition is 0.1% by weight or more and less than 1.5% by weight, a half-mirror-like finish with a glossy surface, namely, see-through appearance allowing to see the background, while having glossy feeling, can be printed by discharging an insufficient amount of ink to cover a printing surface, whereas a metallic finish with high gloss can be formed by discharging a sufficient amount of ink to cover the printing surface. Therefore, for example, such an ink composition is suitable for forming a half-mirror image or a metallic finish with a high gloss on a transparent recording medium. When the concentration of the metallic pigment in the ink composition is 1.5% by weight or more and 3.0% by weight or less, a matt metallic finish not having a high gloss can be formed because the metallic pigment is randomly arranged on the printing surface. Accordingly, for example, such an ink composition is suitable for forming a shield layer on a transparent recording medium.

The organic solvent is preferably a polar organic solvent, and examples thereof include alcohols (for example, methyl alcohol, ethyl alcohol, propyl alcohol, butyl alcohol, isopropyl alcohol, and fluorinated alcohols), ketones (for example, acetone, methyl ethyl ketone, and cyclohexanone), carboxylic acid esters (for example, methyl acetate, ethyl acetate, propyl acetate, butyl acetate, methyl propionate, and ethyl propionate), and ethers (for example, diethyl ether, dipropyl ether, tetrahydrofuran, and dioxane).

In particular, the organic solvent preferably contains one or more alkylene glycol ethers that are liquids at ordinary temperature and pressure.

Examples of the alkylene glycol ethers include ethylene glycol ethers and propylene glycol ethers based on each group of aliphatic groups of methyl, n-propyl, i-propyl, n-butyl, i-butyl, hexyl, and 2-ethylhexyl; allyl groups having double bonds; and phenyl groups. These alkylene glycol ethers are colorless and low in odor, and, since they have an ether group and a hydroxyl group in each molecule, have both characteristics from the alcohols and the ethers and are liquid at ordinary temperature. In addition, monoethers in which only one hydroxyl group is substituted and diethers in which both hydroxyl groups are substituted can be used in a combination thereof.

In particular, the organic solvent is preferably a mixture of an alkylene glycol diether, an alkylene glycol monoether, and a lactone.

Examples of the alkylene glycol monoether include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, propylene glycol monomethyl ether, propylene glycol monoethyl ether, dipropylene glycol monomethyl ether, and dipropylene glycol monoethyl ether.

Examples of the alkylene glycol diether include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Examples of the lactone include γ-butyrolactone, δ-valerolactone, and ∈-caprolactone.

By providing such a suitable constitution, the object of the invention can be further achieved.

Examples of the resin contained in the ink composition include acrylic resins, styrene-acrylic resins, rosin-modified resins, terpene resins, polyester resins, polyamide resins, epoxy resins, vinyl chloride resins, vinyl chloride-vinyl acetate copolymers, fiber-based resins (for example, cellulose acetate butyrate and hydroxypropyl cellulose), polyvinyl butyral, polyacrylic polyol, polyvinyl alcohol, and polyurethane.

The resin used may also be a nonaqueous emulsion polymer microparticles (non-aqueous dispersion: NAD), which is a dispersion prepared by stably dispersing microparticles of, for example, a polyurethane resin, an acrylic resin, or an acrylic polyol resin in an organic solvent.

Examples of the polyurethane resin include Sanprene IB-501 and Sanprene IB-F370, manufactured by Sanyo Chemical Industries, Co., Ltd. Examples of the acrylic polyol resin include N-2043-60MEX, manufactured by Harima Chemicals, Inc.

The resin emulsion is preferably added to the ink composition in an amount of 0.1% by weight or more and 10% by weight or less for further increasing the adhesion ability of the pigment to a recording medium. If the additive amount is excessive, a printing stability is not achieved, and the amount is too small, the adhesion ability is insufficient.

The ink composition preferably contains one or more of glycerin, polyalkylene glycol, and saccharides. The total amount of the one or more of glycerin, polyalkylene glycol, and saccharides is preferably 0.1% by weight or more and 10% by weight or less of that of the ink composition.

By providing such a suitable constitution, drying of the ink is suppressed, clogging is prevented, discharging of the ink is stabilized, and the image quality of a recorded matter is increased.

The polyalkylene glycol is a linear polymer compound having a structure in which ether bonds are repeated in its main chain and is produced by, for example, ring-opening polymerization of cyclic ethers.

Examples of the polyalkylene glycol include polymers such as polyethylene glycol and polypropylene glycol, ethylene oxide-propylene oxide copolymers, and derivatives thereof. The copolymers may be any of random copolymers, block copolymers, graft copolymers, and alternating copolymers.

Preferred examples of the polyalkylene glycol are represented by the following formula:

HO—(CₙH₂ₙO)ₘ—H

(in the formula, n denotes an integer of 1 to 5, and m denotes an integer of 1 to 100).

In the formula, the integer n in (CₙH₂ₙO)ₘ may be either a single constant or a combination of two or more constants within the above-mentioned range. For example, when n is 3, the formula gives (C₃H₆O)ₘ, and when n is a combination of 1 and 4, the formula gives (CH₂O—C₄H₈O)ₘ. The integer m may be either a single constant or a combination of two or more constants within the above-mentioned range. For example, when m is a combination of 20 and 40 in the above example, the formula gives (CH₂O)₂₀—(C₄H₈O)₄₀, and m is a combination of 10 and 30, the formula gives (CH₂O)₁₀—(C₄H₈O)₃₀. In addition, the integers n and m may be any combination within the above-mentioned ranges.

Examples of the saccharides include monosaccharides such as pentose, hexose, heptose, and octose; polysaccharides such as disaccharides, trisaccharides, and tetrasaccharides; and derivatives thereof, for example, reduced derivatives such as sugar alcohols and deoxy sugars, oxidized derivatives such as aldonic acid and uronic acid, dehydrated derivatives such as glycoseen, amino sugars, and thio sugars. The term “polysaccharides” refers to sugars in a broad sense, including substances that are present widely in nature, such as alginic acid, dextrin, and cellulose.

The ink composition preferably contains at least one acetylene glycol surfactant and/or silicone surfactant. The amount of the surfactant is preferably 0.01% by weight or more and 10% by weight or less of the content of the pigment in the ink composition.

By providing such a suitable constitution, the wettability of the ink composition to a recording medium is improved to provide an ability to rapidly adhere.

Preferred examples of the acetylene glycol surfactant include Surfynol 465 (trademark) and Surfynol 104 (trademark) (which are trade names, manufactured by Air Products and Chemicals, Inc.) and Olfine STG (trademark) and Olfine E1010 (trademark) (which are trade names, manufactured by Nissin Chemical Industry Co., Ltd.).

As the silicone surfactant, polyester-modified silicone or polyether-modified silicone is preferably used. Examples of the silicone surfactant include BYK-347, BYK-348, BYK-UV3500, BYK-UV3570, BYK-UV3510, and BYK-UV3530 (BYK-Chemie Japan K.K.).

The ink composition can be prepared by a well-known common method. For example, a pigment dispersion containing a surface-treated metallic pigment is prepared by, first, mixing the above-mentioned metallic pigment, a dispersant, and the above-mentioned solvent, preparing a pigment dispersant using a ball mill, a bead mill, or a jet mill or by sonication, and then adding an alkoxysilane compound having at least one long-chain alkyl group to the dispersion. The resulting pigment dispersion is adjusted so as to have desired ink characteristics, followed by addition of a binder resin, the solvent, and other additives (such as a dispersion aid and a viscosity modifier) with stirring to give the pigment ink composition.

As another example, the composite pigment base substrate is sonicated in a solvent once to form a composite pigment dispersion, and then the dispersion may be mixed with a necessary ink solvent. Alternatively, the composite pigment base substrate may be directly sonicated in an ink solvent to form an ink composition.

The physical properties of the ink composition are not particularly limited, but, for example, the surface tension is preferably 20 to 50 mN/m. When the surface tension is lower than 20 mN/m, the ink composition widely wets the surface of a head of an ink jet recording printer or exudes from the head, which may make the discharge of ink droplets difficult. When the surface tension is higher than 50 mN/m, the ink composition does not suitably wet the surface of a recording medium, which may prevent satisfactory printing.

### Ink Set

The ink set of the embodiment includes a plurality of the ink compositions, and the metallic pigment concentrations of the ink compositions differ from one another.

Among the ink compositions, preferably, at least one ink composition has a metallic pigment concentration of 0.1% by weight or more and less than 1.5% by weight, and at least another ink composition has a metallic pigment concentration of 1.5% by weight or more and 3.0% by weight or less.

### Ink Jet Recording Method

In the ink jet recording method of the embodiment, recording is conducted by discharging droplets of the ink composition and attaching the droplets onto a recording medium.

From the viewpoint of angular dependence, an image formed on a recording medium preferably has a metallic gloss showing measurement values of relative-specular glossiness at 20°, 60°, and 85° specified in JIS 28741 of 200 or more, 200 or more, and 100 or more, respectively, at the same time, more preferably showing measurement values of relative-specular glossiness at 20°, 60°, and 85° specified in JIS Z8741 of 400 or more, 400 or more, and 100 or more, respectively, at the same time, and further preferably showing measurement values of relative-specular glossiness at 20°, 60°, and 85° specified in JIS 28741 of 600 or more, 600 or more, and 100 or more, respectively, at the same time.

When the measurement values of relative-specular glossiness at 20°, 60°, and 85° specified in JIS 28741 are 200 or more and less than 400, 200 or more and less than 400, and 100 or more, respectively, at the same time, the image has a matt finish.

When the measurement values of relative-specular glossiness at 20°, 60°, and 85° specified in JIS 28741 are 400 or more and less than 600, 400 or more and less than 600, and 100 or more, respectively, at the same time, the image has a metallic gloss such that an object reflected on the image can be slightly recognized.

When the measurement values of relative-specular glossiness at 20°, 60°, and 85° specified in JIS 28741 are 600 or more, 600 or more, and 100 or more, respectively, at the same time, the image has a sharpness and a gloss such that an object reflected on the image can be clearly recognized, namely, a metallic gloss having so-called “specular gloss”.

Therefore, according to the ink jet recording method of the embodiment, an image can be formed on a recording medium so as to have a desired metallic gloss, ranging from a matt image to a glossy image, by appropriately combining images having metallic gloss showing measurement values of relative-specular glossiness at 20°, 60°, and 85° specified in JIS Z8741 of 200 or more, 200 or more, and 100 or more, respectively, at the same time.

On the other hand, when the measurement values of relative-specular glossiness at 20°, 60°, and 85° are less than 200, less than 200, and less than 100, respectively, visual inspection of the image detects no metallic gloss, but observes gray color. In addition, when any of the measured values of relative-specular glossiness at 20°, 60°, and 85° is lower than the above-mentioned values, the effects of the invention cannot be achieved.

The amount of the ink composition discharged on a recording medium is preferably 0.1 to 100 mg/cm² and more preferably 1.0 to 50 mg/cm² from the viewpoints of securing a metallic gloss, printing process, and cost performance.

The dry weight of the metallic pigment forming an image on a recording medium is preferably 0.0001 to 3.0 mg/cm² from the viewpoints of securing a metallic gloss, printing process, and cost performance. A smaller dry weight of the metallic pigment allows forming a surface with a high metallic gloss. Therefore, for example, it is suitable for forming a half-mirror image on a transparent recording medium. In addition, a larger dry weight of the metallic pigment allows forming a surface with a matt metallic finish. Therefore, for example, it is suitable for forming a shield layer on a transparent recording medium.

Examples of the method for discharging the ink composition include the below-described methods.

A first method is an electrostatic attraction system. In this system, recording is performed by applying a strong electric field between a nozzle and an acceleration electrode disposed ahead of the nozzle to sequentially eject ink droplets from the nozzle; and applying printing information signals to deflection electrodes while the ink droplets are traveling between the deflection electrodes, or ejecting the ink droplets according to printing information signals without deflecting the ink droplets.

A second method is a system in which an ink solution is applied with a pressure by a small-sized pump, and a nozzle is mechanically vibrated using a quartz oscillator or the like to forcedly eject ink droplets. In this system, recording is performed by charging the ejected ink droplets at the time of ejection, and applying printing information signals to deflection electrodes while the ink droplets are traveling between the deflection electrodes.

A third method is a system using a piezoelectric element (piezo element), and an ink solution is simultaneously applied with a pressure and a printing information signal by the piezoelectric element for ejecting ink droplets for recording.

A fourth method is a system in which an ink solution is sharply expanded in volume by a thermal energy effect. The ink solution is heated with a microelectrode according to printing information signals to form foam for ejecting ink droplets for recording.

Any of the above-mentioned systems can be applied to the ink jet recording method of the embodiment, but the system in which the ink composition is discharged by a non-heating system is preferred from the viewpoint of corresponding to high-speed printing. That is, the first, second, and third methods are preferred.

The recording medium is not particularly limited, and various recording media, for example, plain paper, paper exclusive for ink jet recording (mat printing paper, glossy printing paper), glass, a plastic film such as a vinyl chloride sheet, a coated film in which a substrate is coated with a plastic or receiving layer, a metal, and a printed circuit board, can be used.

When the recording medium has an ink-receiving layer, printing without heating the recording medium is preferred from the viewpoint of avoiding damage caused by heat.

On the other hand, when the recording medium does not have an ink-receiving layer, printing with heating the recording medium is preferred from the viewpoints of enhancing the drying rate and obtaining a high gloss.

Examples of the heating process include a method in which a heat source is brought into contact with the recording medium for heating and a method in which the recording medium is irradiated with infrared rays or microwaves (electromagnetic waves having a maximum wavelength of about 2450 MHz) or blowing hot air without a contact with the recording medium.

The heating is preferably conducted before the printing and/or during the printing and/or after the printing. In other words, the heating of the recording medium may be conducted in advance, during, or after the printing or may be conducted throughout the printing. The heating temperature depends on the type of a recording medium, and is preferably 30 to 80° C. and more preferably 40 to 60° C.

### Recorded Matter

The recorded matter of the embodiment is one in which recording is performed by the above-mentioned ink jet recording method. The recorded matter is obtained by the ink jet recording method using the above-mentioned ink set and therefore has a high metallic specular gloss showing values of relative-specular glossiness at 20°, 60°, and 85° of 200 or more, 200 or more, and 100 or more, respectively. In addition, since the metallic pigment concentrations in the ink compositions of the ink set differ from one another, arbitrary levels of metallic gloss, ranging from a specular gloss to a mat finish, can be simultaneously formed.

### EXAMPLES

### Examples 1 to 3

### 1. Preparation of Metallic Pigment Dispersion

A resin layer coating liquid composed of 3.0% by weight of cellulose acetate butyrate (degree of butylation: 35 to 39%, manufactured by Kanto Chemical Co., Inc.) and 97% by weight of diethylene glycol diethyl ether (manufactured by Nippon Nyukazai Co., Ltd.) was uniformly applied onto a PET film having a thickness of 100 μm by bar coating, followed by drying at 60° C. for 10 minutes to form a resin layer thin film on the PET film.

Then, an aluminum deposition layer having an average thickness of 20 nm was formed on the resin layer using a vacuum deposition apparatus (model VE-1010 vacuum deposition apparatus, manufactured by Vacuum Device Inc.).

Then, the laminate formed by the above method was simultaneously peeled, pulverized so as to be reduced in size, and dispersed in diethylene glycol diethyl ether using a ultrasonic disperser model VS-150 (manufactured by As One Corp.) to prepare a pigment dispersion containing a metallic pigment that have been subjected to ultrasonic dispersion treatment for 12 hours in total.

Then, hexyltrimethoxysilane was added to the pigment dispersion in a concentration of 0.025 mol/L, and a reaction was performed at 20° C. for 24 hours to prepare a metallic pigment dispersion. The metallic pigment in this case had a 50% average particle size (R50) of 0.89 μm and a thickness Z of 0.02 μm, and the value of R50/Z was 44.5.

The resulting metallic pigment dispersion was filtered through an SUS mesh filter with a pore size of 5 μm to remove coarse particles. Then, the filtrate was put in a round-bottomed flask, and diethylene glycol diethyl ether was evaporated using a rotary evaporator. By doing so, the metallic pigment dispersion was concentrated, and then the concentration of the metallic pigment in the dispersion was adjusted to 5% by weight to obtain a metallic pigment dispersion 1.

Furthermore, pigment dispersions 2 and 3 were prepared as in the pigment dispersion 1 except that hexyltriethoxysilane and decyltriethoxysilane were respectively used instead of the hexyltrimethoxysilane.

Furthermore, as Comparative Example, a metallic pigment dispersion 4 was prepared as in the metallic pigment dispersion 1 except that the hexyltrimethoxysilane contained in the pigment dispersion 1 was not added.

### 2. Preparation of Metallic Pigment Ink Composition

Metallic pigment ink compositions having compositions shown in Table 1 were prepared using the metallic pigment dispersions prepared by the above-mentioned method. The solvent and the additives were mixed and dissolved to prepare an ink solvent. The metallic pigment dispersions were each added in the ink solvent, followed by mixing and stirring at ordinary temperature and pressure for 30 minutes with a magnetic stirrer to give the respective metallic pigment ink compositions.

In Table 1, diethylene glycol diethyl ether (DEGDE) and tetraethylene glycol dimethyl ether (TEGDM) were those manufactured by Nippon Nyukazai Co., Ltd.); γ-butyrolactone was that manufactured by Kanto Chemical Co., Inc.; and cellulose acetate butyrate was that having a degree of butylation of 35 to 39% manufactured by Acros Organic. The unit was % by weight.

TABLE 1

| | | | | Com- |
|---|---|---|---|---|
| | | | | parative |
| | Example 1 | Example 2 | Example 3 | Example |
| Use of metallic pigment | 1.5 | — | — | — |
| dispersion 1 (solid conc.) | | | | |
| Use of metallic pigment | — | 1.5 | — | — |
| dispersion 2 (solid conc.) | | | | |
| Use of metallic pigment | — | — | 1.5 | — |
| dispersion 3 (solid conc.) | | | | |
| Use of metallic pigment | — | — | — | 1.5 |
| dispersion 4 (solid conc.) | | | | |
| Diethylene glycol | 67.5 | 67.5 | 67.5 | 67.5 |
| diethyl ether | | | | |
| γ-Butyrolactone | 15 | 15 | 15 | 15 |
| Tetraethylene glycol | 15 | 15 | 15 | 15 |
| dimethyl ether | | | | |
| Cellulose acetate butyrate | 0.5 | 0.5 | 0.5 | 0.5 |
| BYK-3500 | 0.5 | 0.5 | 0.5 | 0.5 |

### 3. Evaluation Test

### (1) Measurement of Glossiness

A solid image was printed using an ink jet printer SP-300V (manufactured by Roland D.G.) of which block column was filled with an ink composition on a glossy vinyl chloride sheet SV-G-610G having an ink-receiving layer manufactured by the company at a heater temperature of 40° C. under surrounding conditions of room temperature. In this case, the discharge amount of the ink composition was 1.2 mg/cm², and the dry weight of the metallic pigment was 12 μg/cm². The glossiness of the resulting image was measured with a glossmeter (MULTI Gloss 268, manufactured by Konica Minolta, Inc.). Table 2 shows the results.

TABLE 2

| | Glossiness at 20° | Glossiness at 60° |
|---|---|---|
| Example 1 | 285 | 384 |
| Example 2 | 264 | 380 |
| Example 3 | 277 | 386 |
| Comparative Example | 251 | 368 |

1. A surface-treated pigment, the pigment being a metallic pigment composed of plate-like particles of which surfaces are treated with an alkoxysilane compound having at least one long-chain alkyl group.

2. The surface-treated pigment according to claim 1, wherein the long-chain alkyl group in the alkoxysilane compound has 4 to 12 carbon atoms.

3. The surface-treated pigment according to claim 1, wherein the metallic pigment composed of the plate-like particles has flat surfaces with a major axis X, a minor axis Y, and a thickness Z that satisfy the requirements that the 50% average particle size R50 based on circle-equivalent diameters determined from the X-Y plane areas of the plate-like particles is from 0.5 to 3 μm and the value of R50/Z is larger than 5.

4. The surface-treated pigment according to claim 1, wherein the maximum particle size Rmax based on circle-equivalent diameters determined from the X-Y plane areas of the plate-like particles is 10 μm or less.

5. The surface-treated pigment according to claim 1, wherein the metallic pigment is aluminum or an aluminum alloy.

6. The surface-treated pigment according to claim 1, wherein the metallic pigment is produced by pulverizing a deposited metal film.

7. An ink composition, comprising the surface-treated pigment according to claim 1, an organic solvent, and a resin.

8. The ink composition according to claim 7, wherein the ink composition contains the surface-treated metallic pigment in a concentration of 0.1 to 3.0% by weight.

9. The ink composition according to claim 7, wherein the organic solvent contains at least one alkylene glycol ether that is a liquid at ordinary temperature and ordinary pressure.

10. The ink composition according to claim 7, wherein the organic solvent is a mixture of an alkylene glycol diether, an alkylene glycol monoether, and a lactone.

11. The ink composition according to claim 7, wherein the resin is at least one selected from the group consisting of polyvinyl butyral, cellulose acetate butyrate, and polyacrylic polyol resins.

12. An ink jet recording method for recording by discharging droplets of the ink composition according to claim 7 and attaching the droplets onto a recording medium, wherein the amount of the ink composition discharged on the recording medium is 0.1 to 100 mg/cm².

13. The ink jet recording method according to claim 12, wherein the ink composition is discharged by a non-heating system.

14. The ink jet recording method according to claim 12, wherein the printing is conducted with heating the recording medium.

15. The ink jet recording method according to claim 14, wherein the heating temperature is 30 to 80° C.

16. The ink jet recording method according to claim 15, wherein the heating is conducted before the printing and/or during the printing and/or after the printing.
